(19) United States
(12) Patent Application Publication
(10) Pub. No.: US 2022/0182334 A1
(43) Pub. Date: Jun. 9, 2022

(54) METHOD AND APPARATUS FOR RETURNING EXECUTION RESULT OF FUNCTION IN NAME-BASED IN-NETWORK DISTRIBUTED COMPUTING SYSTEM

(71) Applicant: ELECTRONICS AND TELECOMMUNICATIONS RESEARCH INSTITUTE, Daejeon (KR)

(72) Inventors: Sae Hoon KANG, Daejeon (KR); Ji Soo SHIN, Daejeon (KR); Nam Seok KO, Daejeon (KR)

(21) Appl. No.: 17/508,875

(22) Filed: Oct. 22, 2021

(30) Foreign Application Priority Data
Dec. 7, 2020 (KR) 10-2020-0169195

(51) Int. Cl. H04L 12/927; H04L 12/911; H04L 12/721; G06F 9/48

(52) U.S. Cl. CPC H04L 47/803; H04L 47/78; G06F 9/4881; H04L 45/44; H04L 47/829

(57) ABSTRACT

The present invention relates to an apparatus and method for returning execution result of function in name-based in network distributed computing system. The present invention includes sending a first packet requesting execution of a function to a first node; transmitting a second packet requesting the execution result of the function to a second node; and receiving, after transmitting the second packet, a third packet, which comprises the execution result of the function, from the second node.

### CROSS-REFERENCE TO RELATED APPLICATION

The present application claims priority to Korean Patent Application No. 10-2020-0169195, filed Dec. 7, 2020, the entire content of which is incorporated herein for all purposes by this reference.

### BACKGROUND OF THE INVENTION

### 1. Field of the Invention

The present invention relates to a name-based in-network distributed computing system and particularly to an apparatus and method for returning an execution result of a function in a name-based in-network distributed computing system.

### 2. Description of Related Art

As the recent trend of Internet applications moves to the production and transfer of massive contents, the existing host-based point-to-point communication mechanism is replaced by the concept of information centric networking (ICN) focusing on data themselves. According to ICN technology, names are given to all the data, a user makes a request to a network by specifying a name of desired data, and the network searches and transfers data matching the name to the user. Representative ICN projects are content centric networking (CCN) and named data networking (NDN).

### SUMMARY

The present invention may provide a method and apparatus for effectively returning an execution result of a function in a name-based in-network distributed computing system.

The present invention may provide a method and apparatus for executing a function and returning a result by using different independent logics in a name-based in-network distributed computing system.

The present invention may provide a method and apparatus for executing a function and returning an execution result in an environment that is designed to develop an executable code without dependence on a method of returning the execution result of the function in a name-based in-network distributed computing system.

According to an embodiment of the present invention, a method for operating a client device in a name-based in-network distributed computing system may include: transmitting a first packet, which requests execution of a function, to a first node; transmitting a second packet, which requests an execution result of the function, to a second node; and receiving, after transmitting the second packet, a third packet including the execution result of the function from the second node.

Herein, the first packet may include at least one among information designating the function, information on at least one input variable for executing the function, and information for identifying an execution result of the function.

According to an embodiment of the present invention, the method may further include receiving, from the first node, a fourth packet including information on an instance that is generated for executing the function.

According to an embodiment of the present invention, the first node may include a device having a resource for in-network computing, and the second node may include a device having a storage means for storing and providing an execution result of the function.

According to an embodiment of the present invention, the method may further include determining an operation mode of the function among multiple candidate modes. The multiple candidate modes may include a first mode, which obtains the execution result from a node executing the function, and a second node that obtains the execution result from a different node from the node executing the function.

According to an embodiment of the present invention, information for identifying the execution result of the function may include a key value that is to be used in a node providing the execution result.

According to an embodiment of the present invention, information on at least one input variable for executing the function may include information for identifying an execution result of another function.

According to an embodiment of the present invention, the method may further include: generating a function call handler (FCH) for calling the function; and generating a get result handler (GRH) for obtaining an execution result of the function.

Herein, the FCH may be deleted after requesting execution of the function by using the first packet, and the GRH may be deleted after obtaining the execution result of the function by using the third packet.

According to an embodiment of the present invention, the method may further include determining, by using the FCH, a key value that matches the execution result of the function.

According to an embodiment of the present invention, the second packet may include information for identifying the execution result of the function.

According to an embodiment of the present invention, the method may further include receiving the sixth packet including information for identifying the execution result of the function.

According to an embodiment of the present invention, a method for operating an in-network computing server in a name-based in-network distributed computing system may include: receiving a first packet, which requests execution of a function, from a client device; executing the function; and transmitting, to a storage node, a second packet that requests to store an execution result of the function.

Herein, the first packet may include at least one among information designating the function, information on at least one input variable for executing the function, and information for identifying an execution result of the function.

According to an embodiment of the present invention, the method may further include transmitting, to the client device, a third packet including information on an instance that is generated for executing the function.

According to an embodiment of the present invention, the second packet may include the execution result and information for identifying the execution result of the function.

According to an embodiment of the present invention, information for identifying the execution result of the function may include a key value that is to be used in the storage node.

According to an embodiment of the present invention, the executing of the function may include: allocating a computing resource for executing the function; executing the function by using the computing resource; and returning the computing resource, when it is confirmed that the execution result is stored in the storage node.

According to an embodiment of the present invention, the executing of the function may include generating an instance for executing the function. The instance may include an operation logic of the function, a function handler executing the operation logic and a result handler processing the return of the execution result.

According to an embodiment of the present invention, information on at least one input variable for executing the function may include information for identifying an execution result of another function.

According to an embodiment of the present invention, the executing of the function may include: obtaining data, which includes an execution result of the another function, from the storage node by using information for identifying the execution result of the another function; and executing the function by using the data.

According to an embodiment of the present invention, a client device in a name-based in-network distributed computing system includes a transceiver configured to transmit and receive information and a processor configured to control the transceiver. The processor may control to transmit a first packet, which requests to execute a function, to a first node, to transmit a second packet, which requests an execution result of the function, to a second node, and to receive a third packet including the execution result of the function from the second node after transmitting the second packet. Herein, the first packet may include at least one among information designating the function, information on at least one input variable for executing the function, and information for identifying an execution result of the function.

According to an embodiment of the present invention, an in-network computing server in a name-based in-network distributed computing system includes a transceiver configured to transmit and receive information and a processor configured to control the transceiver. The processor may control to receive a first packet, which requests to execute a function, from a client device, to execute the function, and to transmit a second packet, which requests to store an execution result of the function, to a storage node. Herein, the first packet may include at least one among information designating the function, information on at least one input variable for executing the function, and information for identifying an execution result of the function.

According to the present invention, in a name-based in-network distributed computing system, usage efficiency of a computing resource for executing a function and returning a result may be increased, and the burden of developing an executable code for returning an execution result of a function may be decreased.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view showing a name-based in-network distributed computing system according to an embodiment of the present invention.

FIG. 2 is a view showing a configuration of an apparatus according to an embodiment of the present invention.

FIG. 3 is a view showing a function call procedure in a name-based in-network distributed computing system according to an embodiment of the present invention.

FIG. 4A and FIG. 4B are views showing examples of program codes for function call.

FIG. 5 is a view showing an in-network computing function call procedure in a name-based in-network distributed computing system according to an embodiment of the present invention.

FIG. 6A and FIG. 6B are views showing examples of in-network computing function instances.

FIG. 7 is a view showing a function call procedure using an in-network computing function wrapper in a name-based in-network distributed computing system according to an embodiment of the present invention.

FIG. 8 is a view showing a function call procedure in a case where an execution result of a function is transferred as an input as another function in a name-based in-network distributed computing system according to an embodiment of the present invention.

FIG. 9 is a view showing an operation procedure of a client in a name-based in-network distributed computing system according to an embodiment of the present invention.

FIG. 10 is a view showing an operation procedure of an in-network computing server in a name-based in-network distributed computing system according to an embodiment of the present invention.

### DETAILED DESCRIPTION

Hereinafter, embodiments of the present disclosure will be described in detail with reference to the accompanying drawings so that those of ordinary skill in the art to which the present disclosure pertains can easily implement them. However, the present disclosure may be implemented in several different forms and is not limited to the embodiments described herein.

In describing an embodiment of the present disclosure, if it is determined that a detailed description of a well-known configuration or function may obscure the gist of the present disclosure, a detailed description thereof will be omitted. And, in the drawings, parts not related to the description of the present disclosure are omitted, and similar reference numerals are attached to similar parts.

In the present disclosure, when it is said that a component is “connected”, “coupled” or “connected” to another component, it is not only a direct connection relationship, but also an indirect connection relationship in which another component exists in the middle. may also include. In addition, when it is said that a component “includes” or “has” another component, it means that another component may be further included without excluding other components unless otherwise stated.

In the present disclosure, terms such as first, second, etc. are used only for the purpose of distinguishing one component from other components, and unless otherwise specified, the order or importance of the components is not limited. Accordingly, within the scope of the present disclosure, a first component in one embodiment may be referred to as a second component in another embodiment, similarly, the second component in one embodiment may be referred to as a first component in another embodiment.

In the present disclosure, components that are distinguished from each other are for clearly explaining each characteristic, and do not necessarily mean that the components are separated. That is, a plurality of components may be integrated to form one hardware or software unit, or one component may be distributed to form a plurality of hardware or software units. Therefore, even if not separately mentioned, such integrated or distributed embodiments are also included in the scope of the present disclosure.

In the present disclosure, components described in various embodiments do not necessarily mean essential components, and some may be optional components. Accordingly, an embodiment composed of a subset of components described in an embodiment is also included in the scope of the present disclosure. In addition, embodiments including other components in addition to components described in various embodiments are also included in the scope of the present disclosure.

Advantages and features of the present invention, and a method of achieving them will become apparent with reference to the embodiments described below in detail in conjunction with the accompanying drawings. However, the present invention is not limited to the embodiments presented below, but may be implemented in a variety of different forms, only the present embodiments are provided so that the disclosure of the present invention is complete, and to completely inform those of ordinary skill in the art to which the present invention pertains to the scope of the invention.

Hereinafter, the present invention relates to an apparatus and method for returning an execution result of a function in a name-based in-network distributed computing system. Specifically, the present invention provides in-network computing (hereinafter referred to as ‘INC’) that supports distributed performance of some computing operations by using computing resources provided by network infrastructure by an application located in a user device in a name-based network environment, with respect to technology, a method and apparatus for receiving operation processing requests of a user application specified based on a name, performing distributed computing work at an appropriate location in a network, and returning the result to a user application.

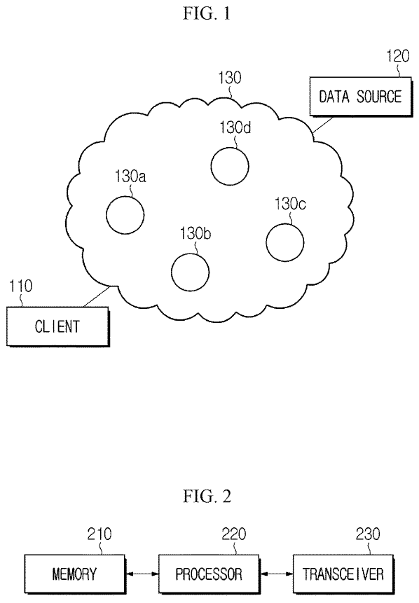

FIG. 1 is a view showing a name-based in-network distributed computing system according to an embodiment of the present invention.

Referring to FIG. 1, a name-based in-network distributed computing system includes a client 110, a data source 120 and a network 130. The network 130 includes a multiplicity of nodes 130a to 130d. The multiplicity of nodes 130a to 130d may include nodes of a same type or nodes of different types.

The client 110 may request and receive a content that is stored in the data source 120. A request for a content and data including a content are transferred via the network 130. Herein, the system of FIG. 1 may support named data networking (NDN) and INC.

When supporting NDN, at least one of the nodes 130a to 130d may be an NDN router. According to NDN, an interest packet and a data packet are used. A data consumer (e.g. the client 110) transmits an interest packet, which specifies a name of desired data, to the network 130, and an NDN router transfers the interest packet to a data publisher (e.g. the data source 120) based on a forwarding information base (FIB). When the interest packet reaches the data publisher, the data publisher transmits a data packet, which includes data specified in the interest packet, to the data consumer. The NDN router provides a function of caching the data, which is transmitted by the NDN router, in a content store (CS) for a predetermined time. While an interest packet is forwarded to a data publisher, if an NDN router is caching data that matches a name specified on the interest packet, the interest packet is not forwarded any longer, and a data packet including data, which is cached in a CS, is transmitted backwards.

When supporting INC, at least one of the nodes 130a to 130d may be an INC server or an INC cluster. INC is a technique with a concept of outsourcing even an operating function for data to a network beyond the level of requesting desired data to a network. The INC technique outsources a necessary operation work to network infrastructure even when there is no sufficient resource in a user device so that the operation work may be processed. In addition, in case the INC technique is utilized, when only an operation result for data present in a network is required, the client 110 may receive only a result of operation for data, which is executed at a location adjacent to the data, and thus network traffic may be reduced.

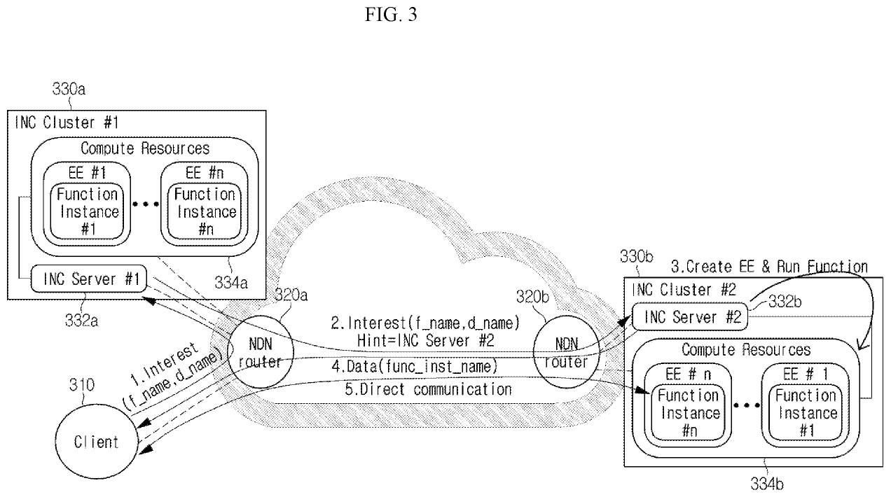

FIG. 2 is a view showing a configuration of an apparatus according to an embodiment of the present invention. FIG. 2 exemplifies the configuration of each device (e.g. the client 110, the data source 120, the multiplicity of nodes 130a to 130d) illustrated in FIG. 1.

Referring to FIG. 2, the apparatus includes a memory 210, a processor 220 and a transceiver 230. The memory 210 may store a program necessary to operate the apparatus, a command and other information. The processor 220 controls the overall operation of the apparatus. The transceiver 230 transmits data to outside the apparatus or receives data from outside. The processor 220 may execute functions necessary to make the apparatus operate according to embodiments described below.

In order to support in-network distributed computing in an NDN network, cross reference between a main program, which is executed in a user node, and a function instance operating in network infrastructure needs to be smoothly supported. In addition, a calculation result generated from one function instance should be available as input data of another function instance. However, since a time required for a function to be executed in a network and to return a result is variable because of the generation of an execution environment, download of an executable code and different complexities of executable codes, a synchronization method is required to exchange an execution result between a program requesting an INC function (hereinafter, referred to as ‘INC requester’) and a function instance.

An INC requester should be able to call an INC function and request and utilize a result when the result is needed. In case an INC requester requests an INC function and keeps waiting until a result is ready or, on the contrary, in case a function instance has to keep waiting because the INC requester has not confirmed a request of result even when a function is completely executed and a result is ready, the efficiency of a computing resource is degraded. This problem will become more significant when a function instance occupies a large resource.

Accordingly, a method for effectively sharing an execution result between an INC requester and a function instance is necessary. From the perspective of a main program that is executed in a user node, synchronous call and asynchronous call should be selectively used as necessary. In addition, from the perspective of a function instance, it should be dynamically determined whether to keep waiting while maintaining a calculated result or to store the calculated result using such a service as repository supported by network infrastructure, end the execution of a function and return a computing resource.

To this end, a calculation logic of a function and a method of returning a result need to be separated from each other. Thus, a function developer can focus on a calculation logic itself, and a method of transferring a calculation result may be determined independently of a main program. Accordingly, the present invention proposes an orchestration method for sharing an execution result between an INC function requester and a function instance in order to support in-network distributed computing in an NDN network. The proposed technique separates an execution logic of a function and a method of returning a result and thus has an advantage of independently selecting a method of sharing an execution result in a main program as necessary, irrespective of whether an INC function supports it or not.

FIG. 3 is a view showing a function call procedure in a name-based in-network distributed computing system according to an embodiment of the present invention. FIG. 3 exemplifies infrastructure (hereinafter, referred to as ‘INC infrastructure’) supporting NDN-based in-network computing. INC infrastructure may include an NDN network and at least one INC cluster 330a and 330b for executing an INC function, and one INC cluster 330a may consist of an INC server 332a for INC management and a computing resource 334a. Generally, the computing resource 334a may consist of one or more servers. Referring to FIG. 3, an INC function call procedure in INC infrastructure may be described as follows.

In step S1, the client 310 node transmits, to a network, an INC interest packet that includes a function name (e.g. f_name) to be called from an application program in operation and information on data (e.g. d_name) to be processed. The interest packet is transferred to the INC server 332a, which is a closest INC server. Herein, the application program may specify a positioning policy for determining a function execution location, a constraint and the like in the interest packet. For example, the positioning policy may be defined as priority of proximity to data, priority of proximity to a client and the like, and a location capable of accepting a resource allocation request of CPU, GPU and memory as constraint may be defined. In this embodiment, for INC interest forwarding, an INC interest packet has a name beginning with a specific prefix of ‘/INC/”. Every INC server advertises an “/INC/” name and its own name to a network, and the information thus advertised is registered to FIB of the NDN routers 320a and 320b.

The INC server 332a of the first INC cluster 330a, which receives an INC interest packet from the client 310, selects an optimal cluster for executing a requested function by considering a user's positioning policy and constraint. In this embodiment, the second INC cluster 330b is selected. Accordingly, in the step S2, the INC server 332a transfers the INC interest packet to the INC server 332b which is in charge of the second INC cluster 330b. By designating a forwarding hint supported by NDN, the interest packet may be transferred between INC servers 322a and 322b with no change in interest name.

In the step S3, the INC server 332b, which receives the INC interest packet, is allocated a computing resource 334b within the second INC cluster 330b managed by the INC server 332b, generates an execution environment (EE) and generates a function instance by downloading and executing a function-executable code. Herein, the function instance thus generated is given a name accessible to the client 310.

In the step S4, the INC server 330b transmits a data packet to the client 310. The data packet includes a name (e.g. func_inst_name) of a function instance. That is, as a name of a function instance is included in an INC data packet, the name is transferred to an application program of the client 310. A name of a function instance is used to request an execution result of function later.

In the step S5, the client 310 and the computing resource 334b of the second INC cluster 330b perform direct communication. Thus, the client 310 is capable of obtaining a function execution result. Herein, a name (e.g. Func_inst_name) of a function instance is used. Specifically, an application program of the client 310 may request a function execution result by sending an NDN interest packet, which includes the received name of the function instance, and receive the function execution result.

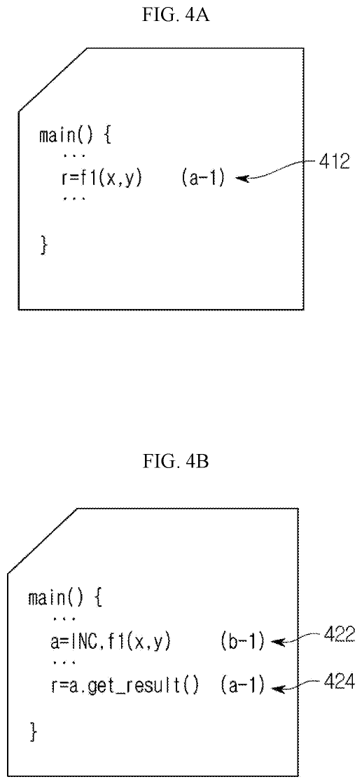

Herein, FIG. 4A and FIG. 4B below compare an INC function call used in an NDN application program and a general function call. FIG. 4A and FIG. 4B are views showing examples of program codes for function call. FIG. 4A and FIG. 4B show examples of application programs for comparing usages between a general function call and an INC function call in an NDN application program. In the case of a general function call, since operation is directly performed in a local machine, a corresponding result is returned at the same time as the function call and is stored in a designated variable. Referring to FIG. 4A, the function f1 is called on the (a-1) line 412, and a result is directly stored in the variable r. On the other hand, in the case of an INC function call, since operation is performed not in a local machine but in a remote machine and a result is returned, the execution of the function and the return are implemented in more steps. Referring to FIG. 4B, when the function f1 is called as an INC function on the (b-1) line 422, a name of a function f1 instance is stored in the variable a according to a procedure similar to the steps S1 to S4 of FIG. 3. Next, when an execution result of a function is needed, as a calculation result is requested to network infrastructure by using an execution instance name stored in the variable a like the (b-2) line 424, the calculation result is stored in the variable r. Since the INC function call takes a longer time to obtain a return value than the general function call, the asynchronous call is generally used. In FIG. 4B, an execution instance of INC function f1 stays in a waiting state until the (b-2) line is called even after operation is completed and should keep waiting until a result request occurs. Such a waiting state causes unnecessary occupancy of a computing resource of infrastructure and degrades resource efficiency. This function execution method is called the standalone mode.

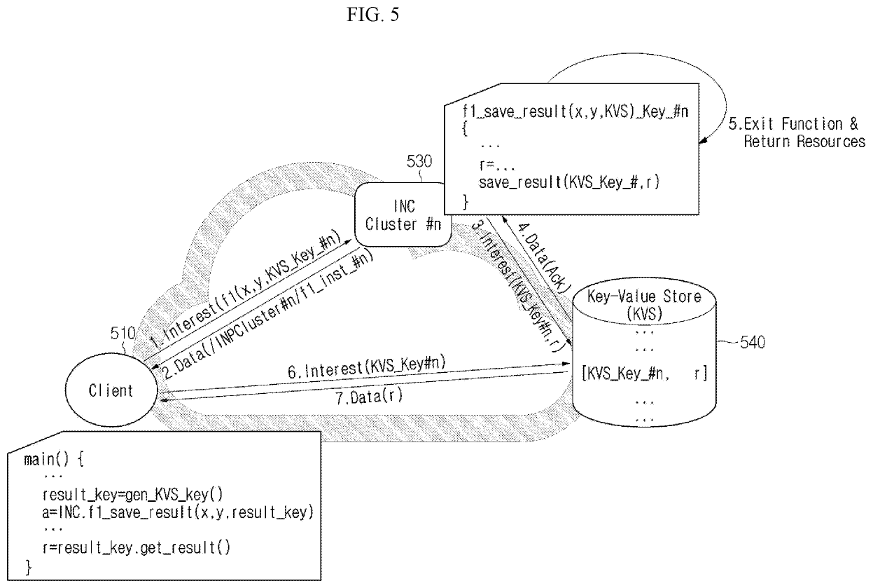

FIG. 5 is a view showing an in-network computing function call procedure in a name-based in-network distributed computing system according to an embodiment of the present invention. FIG. 5 exemplifies an INC function call procedure using a key-value store (KVS) service. In FIG. 5, a KVS node 540 is an entity that stores an execution result of operation and provides the execution result at a request. In FIG. 5, the function f1_save_result, which is executed by a client 510, is programmed to store a result of operation, when the operation is completed, in the KVS node 540 in order to minimize occupancy time of a shared computing time and to return the computing resource by ending the execution of the function.

Referring to FIG. 5, in the step S1, in order to use the function f1_save_result( ), a main program executed in the client 510 generates first KVS key, which is to be used to store a result, and then calls the function by adding the generated KVS key to an argument. Specifically, the client 510 transmits an interest packet, which includes KVS key and input variables (e.g. X, y), to an INC cluster. In addition, in the step S2, the client 510 receives a data packet, which includes a name (e.g. f1_inst_#n) of a function instance, from the INC cluster 530. In this embodiment, it is assumed that every procedure related to using a KVS service is completed beforehand.

When the INC function f1_save_result( ) is called in the client 510, a function instance is generated in an INP cluster 530. For example, like in the step S1 to step S3 of FIG. 3, a function instance may be generated. As the function f_save_result( ) is programmed to store an execution result in the KVS node 540 and to end, the INP cluster 530 in the step S3 requests to store an execution result of the function by transmitting an interest packet, which includes a key value (e.g. KVS Key#n) and an execution result (e.g. r), to the KVS node 540. In the step S4, ACK (acknowledge), which notifies storage of an execution result (e.g. r) in the KVS node 540, is transmitted to the INP cluster 530. Next, in the step S5, the INP cluster 530 ends the function f1_save result( ) and returns a computing resource that is allocated for executing the function. Next, in the step S6, the client 510 requests an execution result of the function by using a KVS key value (e.g. KVS_Key#n) that is used to request the function. Also, in the step S7, the KVS node 540 searches for an execution result (e.g. R) corresponding to the KVS key value (e.g. KVS_Key#n) and transmits a data packet including the execution result to the client 510. In the present invention, the function execution method as shown in FIG. 5 may be called save result mode'.

The function f1 exemplified in FIG. 4B and the function f1_result_save exemplified in FIG. 5 have a same operation logic but have different methods of returning an execution result. A function return method may be dynamically selected according to INC infrastructure environment or a condition of a client. For example, in case INC infrastructure does not provide any KVS service or a main program of a client has no authority to use a KVS service, a return operation based on a KVS service as shown in FIG. 5 will be impossible. In this case, from the function developers' standpoint, developing different types of executable codes in order to accept various return types despite the same operation logic may be a great burden.

In the embodiment described with reference to FIG. 5, a KVS key is generated by the client 510 and is transferred to the INC cluster 530. Herein, according to another embodiment, the KVS key may be generated by the INC cluster 530 or the KVS node 540, not by the client 510.

In case the KVS key is generated by the INC cluster 530, the INC cluster 530 generates the KVS key after receiving a request of function execution. Specifically, after receiving an interest packet, which requests execution of a function, from the client 510, the INC cluster 530 may generate the KVS key and include the KVS key in a data packet that is transmitted in the step S2. Accordingly, the client 510 may request an execution result of the function by using the KVS key that is obtained through the data packet.

In case the KVS key is generated by the KVS node 540, the KVS node 540 generates the KVS key after receiving a request of storing an execution result of the function. Specifically, after receiving an interest packet, which requests to store an execution result of the function, from the INC cluster 530, the KVS node 540 may generate the KVS key and include the KVS key in a data packet that is transmitted in the step S4. Next, the INC cluster 530 may transfer the KVS key to the client 510. For this, an additional packet may be transmitted or the step S2 may be implemented after the step S4.

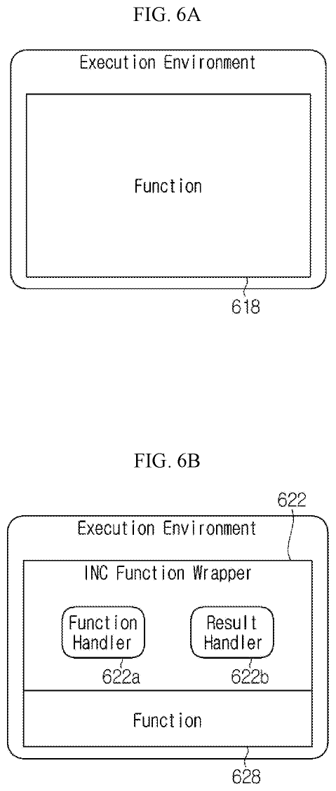

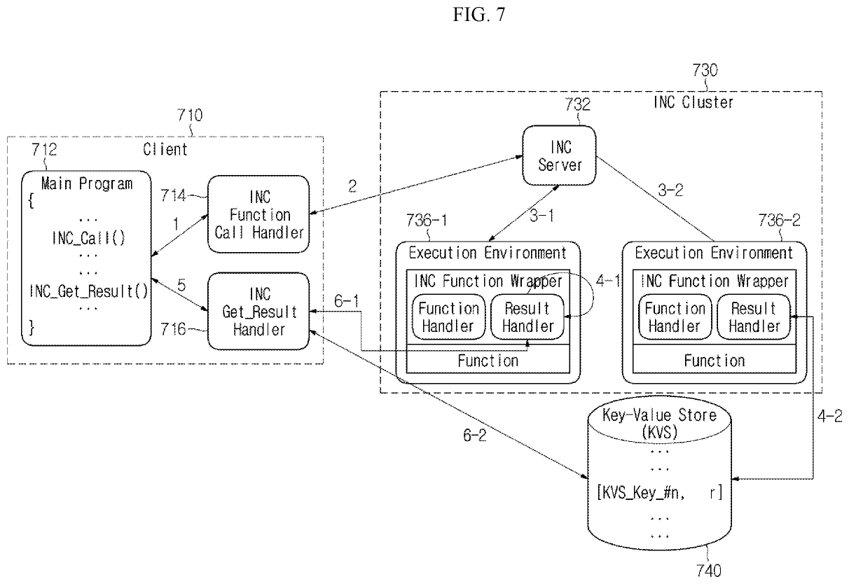

FIG. 6A and FIG. 6B are views showing examples of in-network computing function instances. Like a procedure described with reference to FIG. 3 or FIG. 5, FIG. 6A exemplifies a function instance including an operation logic of a function and an execution result return logic within a function-executable code 618. On the other hand, in FIG. 6B, a function-executable code 628 includes only a part corresponding to an operation logic of a function, and an execution result return logic of the function is included in a result handler 622b of an INC function wrapper (IFW) 622. Unlike the procedure described with reference to FIG. 3 or FIG. 5, in the case of FIG. 6B, the INC function 628 is executed by the function handler 622a of IFW 622, and the result handler 622b processes an execution result by referring to an execution result return method that is transferred during a function call. In this case, a function developer does not have to develop a separate executable code according to an execution result return method.

FIG. 7 is a view showing a function call procedure using an in-network computing function wrapper in a name-based in-network distributed computing system according to an embodiment of the present invention. FIG. 7 exemplifies a procedure of supporting a function call by dynamically designating an operation method of an INC function for a same function-executable code. To this end, an INC FCH (Function Call Handler) 714 and an INC GRH (Get Result Handler) 716 are supported in the client 710. FCH 714 and GRH 716 are dynamically generated, when a main program 712 of the client 710 requests an INC function call and a result, and are automatically deleted when a corresponding role is finished. Operations of calling an INC function and receiving a function execution result in the main program 712 of the client 710 may be described as follows.

Referring to FIG. 7, in the step S1, the main program 712 generates the FCH 714. Specifically, the FCH 714 to be in charge of the function call is generated, and an execution mode regarding a method of returning an execution result together with a function name, which is necessary for the function call, data to be processed, and various types of function setting information is transferred to the FCH 714. In the case of save_result mode, the FCH 714 may determine randomly beforehand which key of KVS is to be mapped with an execution result.

In the step S2, the FCH 714 transmits information necessary for a corresponding function call to a network through an INC interest packet, and the network transfers the INC interest packet to a suitable INC server 732 capable of executing a corresponding request.

In the step S3-1 and the step S3-2, the INC server 732 generates a first execution environment 736-1 and a second execution environment 736-2 and executes IFW according to a function execution mode based on a function factor that is transferred from the client 710 within the generated first execution environment 736-1 and the generated second execution environment 736-2. In this embodiment, a first IFW of the first execution environment 736-1 is executed in the standalone mode, and a second IFW of the second execution environment 736-2 is executed in the save result mode. When the IFWs are executed, a requested function is executed by a function handler, and a function execution mode is transferred to a result handler.

In the step S4-1 and the step S4-2, the result handler stores an execution result of the function. Herein, according to a function execution mode, a result handler of the first IFW temporarily stores an execution result, and a result handler of the second IFW stores an execution result in the KVS node 740.

In the step S5, the main program 712 of the client 710 determines that an INC function execution result is needed and transfers a request for an execution result to the INC GRH 716.

In the step S6-1 or the step S6-2, the GRH 716 of the client 710 transmits an interest packet requesting an execution result. Herein, a target of the request becomes different depending on which operation mode is designated in an existing INC function call. For example, in the case of the standalone mode, a result request interest is transferred to a result handler of a function instance. In the case of the save result, a result request is transferred to the KVS node 740 that is a third storage service device.

In the embodiment described above, the two modes of standalone and save_result are introduced as execution modes of functions, but the present invention is not limited to the execution modes that are exemplified, and it is possible to introduce any other type of execution modes. However, in this case, FCH and IFW should support the execution modes.

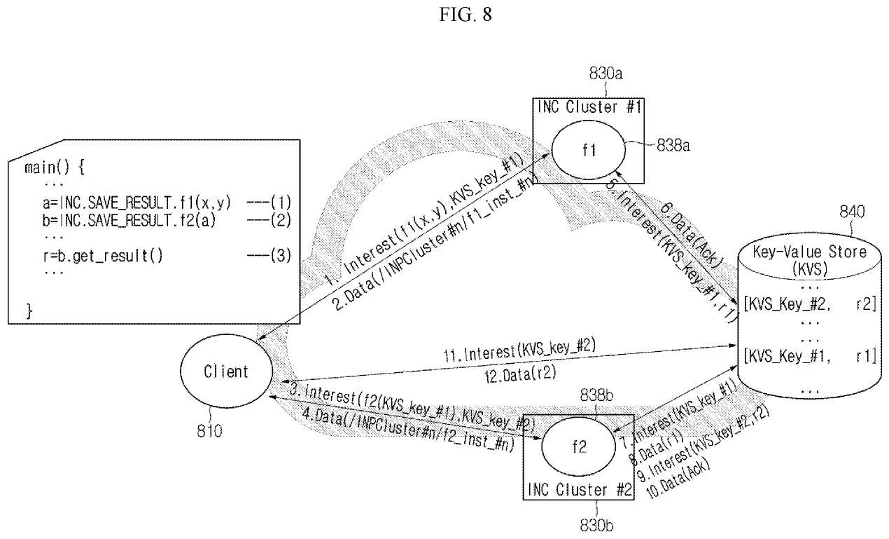

FIG. 8 is a view showing a function call procedure in a case where an execution result of a function is transferred as an input as another function in a name-based in-network distributed computing system according to an embodiment of the present invention. FIG. 8 exemplifies, as an embodiment of NDN-based in-network distributed computing, a situation in which an execution result of one INC function is to be transferred as an input of another function. In the case of a general program, there is no difficulty in transferring an execution result of function f1, which is called on the line (1) of a main program of a client as an input factor of function f2 on the line (2). However, according to an INC function call as in the above-described embodiment, function f2 may be called only after the call of function f1 is completed and a corresponding result is obtained, which may degrade the performance of program.

Accordingly, the present invention proposes an embodiment of calling an INC function in result save mode and thus supporting an asynchronous call of an INC function in a main program irrespective of an execution result of a previous function. When calling a function, it is determined beforehand, by operating an INC function in result save mode, which key of KVS is to be mapped with an execution result, and the key may be used as an execution result name of function f1 instance. Specifically, when calling function f2 that uses a result of function f1 as an input, a main program of a client transfers a data name of a result value, instead of transferring the actual result value of f1. Next, when an execution result value of function f1 is needed in the function f2 instance, the function f2 instance may obtain the result value by using the transferred name and apply the result value to operation.

Referring to FIG. 8, in the step S1, a client 810 transmits an interest packet, which requests execution of function f1, together with input variables (e.g. x, y) to a function f1 instance 838a. Herein, the interest packet includes a KVS key value (e.g. KVS_Key_#1) that is used to store an execution result of function f1. In addition, in the step S2, the client 810 receives a data packet, which includes a name (e.g. f1_inst#n) of a function instance, from the function f1 instance 838a.

In the step S3, the client 810 transmits an interest packet, which requests execution of function f2, to a function f2 instance 838b. Herein, the interest packet includes, as input variables of function f2, a KVS key value (e.g. KVS Key #1), which is used to store an execution result of function f1, and a KVS key value (e.g. KVS_Key_#2) that is used to store an execution result of function f2. In addition, in the step S4, the client 810 receives a data packet, which includes a name (e.g. f2_inst_#n) of a function instance, from the function f2 instance 838b. In this embodiment, function f1 call in the step S1 and function f2 call in the step S3 may be performed almost simultaneously, and accordingly generation of an execution instance may start almost simultaneously.

In the step S5, the function f1 instance 838a executes the function f1 and transmits an interest packet, which includes an execution result (e.g. r1) of the function f1 and a corresponding KVS key value (e.g. KVS key#1), to the KVS node 840. In the step S6, the KVS node 840 stores the execution result (e.g. r1) of the function f1, which is included in the interest packet, and transmits a data packet, which includes ACK notifying success of reception, to the function f1 instance 838a.

In the step S7, the function f2 instance 838b transmits, to the KVS node 840, an interest packet, which includes a KVS key value (e.g. KVS_key#1) transferred as an input factor during the function f2 call, that is, provided by the client 810 to obtain an execution result of function f1. In the step S8, the KVS node 840 searches for an execution result (e.g. r1) of function f1 corresponding to the KVS key value (e.g. KVS_key#1) included in the interest packet and transmits a data packet including the execution result (e.g. r1) of function f1 to the function f2 instance 838b. Thus, the function f2 instance 838b may execute the function f2 by using the execution result (e.g. R1) of function 1 and obtain an execution result (e.g. r2) of function f2.

In the step S9, the function f2 instance 838b transmits, to the KVS node 840, an interest packet that includes the execution result (e.g. r2) of function 2 and a corresponding KVS key value (e.g. KVS_key#2). In the step S10, the KVS node 840 stores the execution result (e.g. r2) of the function f2, which is included in the interest packet, and transmits a data packet, which includes ACK notifying success of reception, to the function f2 instance 838b.

Next, in the step S11, the client 810 transmits an interest packet, which includes a KVS key value (e.g. KVS_key#2) used during the function f2 call, to the KVS node 840. In the step S12, the KVS node 840 searches for an execution result (e.g. r2) of function f2 corresponding to the KVS key value (e.g. KVS_key#2) included in the interest packet and transmits a data packet including the execution result (e.g. r2) of function f2 to the client 810.

In the embodiment described with reference to FIG. 8, a main program of the client 810 calls INC functions and functions as a coordinator regarding which data should be exchanged between functions but is not involved in transferring data between function instances. Thus, developers become capable of programming INC applications in a way not significantly different from the one used for programing applications that are implemented only in existing local machines.

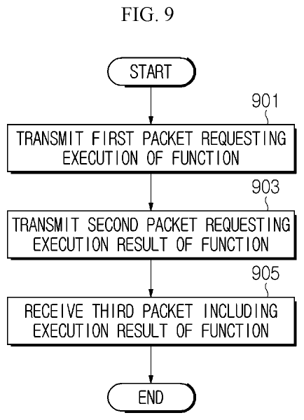

FIG. 9 is a view showing an operation procedure of a client in a name-based in-network distributed computing system according to an embodiment of the present invention.

Referring to FIG. 9, in the step S901, a client transmits a first packet that requests execution of a function. The first packet is transmitted to a device with a resource for in-network computing, for example, an INC server. To this end, the client may generate an FCH for calling a function and a GRH for obtaining an execution result of the function. For example, the first packet may include at least one among information designating a function to be executed, information on at least one input variable for executing the function, and information for identifying an execution result of the function. Herein, the information on at least one input variable may be a value of the input variable or include a value for obtaining the input variable. Herein, the FCH may be deleted after transmitting the first packet that requests execution of the function.

In the step S903, the client transmits a second packet that requests an execution result of the function. The second packet is transmitted to a device having a means of storing and providing the execution result of the function, for example, a KVS node.

For example, the second packet may include information for identifying the execution result of the function. Although not illustrated in FIG. 9, before transmitting the second packet, the client may receive a packet that includes information on an instance which is generated for executing the function. In the step S905, the client receives a third packet including the execution result of the function. The third packet includes data that include the execution result of the function, which is generated by an INC server. Herein, the GRH, which is generated when the function is called, may be deleted after receiving the third packet.

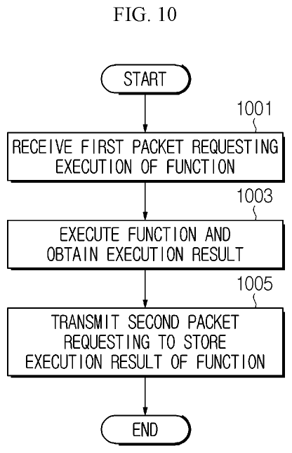

FIG. 10 is a view showing an operation procedure of an in-network computing (INC) server in a name-based in-network distributed computing system according to an embodiment of the present invention.

Referring to FIG. 10, in the step S1001, an INC server receives a first packet that requests execution of a function. For example, the first packet may include at least one among information designating a function to be executed, information on at least one input variable for executing the function, and information for identifying an execution result of the function. Herein, the information on at least one input variable may be a value of the input variable or include a value for obtaining the input variable. Although not illustrated in FIG. 10, after receiving the first packet, the INC server may transmit a packet, which includes information on an instance that is generated for executing the function, to a client.

In the step S1003, the INC server executes the function and obtains the execution result. For example, the INC server allocates a computing resource for executing the function and obtains the execution result by executing the function by means of the computing resource. Specifically, the INC server generates an instance for executing the function. The instance may include an operation logic of the function, a function handler executing the operation logic and a result handler processing the return of the execution result.

In the step S1005, the INC server transmits a second packet that requests to store the execution result of the function. The second packet is transmitted to a device having a means of storing and providing the execution result of the function, for example, a KVS node. Herein, when it is acknowledged that the execution result is stored in the KVS node, the computing resource allocated in the step S1003 is returned.

In order to implement the method according to the present disclosure, other steps may be included in addition to the illustrated steps, other steps may be included except some steps, or additional other steps may be included except some steps.

The various embodiments of the present disclosure do not list all possible combinations, but are intended to illustrate representative aspects of the present disclosure, matters described in various embodiments may be applied independently or in combination of two or more. In addition, various embodiments of the present disclosure may be implemented by hardware, firmware, software, or a combination thereof. For implementation by hardware, one or more application specific Integrated Circuits (ASICs), Digital Signal Processors (DSPs), Digital Signal Processing Devices (DSPDs), Programmable Logic Devices (PLDs), Field Programmable Gate Arrays (FPGAs), general processor, a controller, a microcontroller, a microprocessor, and the like.

The scope of the present disclosure includes software or machine-executable instructions (eg, operating system, application, firmware, program, etc.) that cause an operation according to the method of various embodiments to be executed on a device or computer, and such software or and non-transitory computer-readable media in which instructions and the like are stored and executed on a device or computer.

What is claimed is:

1. A method for operating a client device in a name-based in-network distributed computing system, the method comprising:
transmitting a first packet, which requests execution of a function, to a first node;
transmitting a second packet, which requests an execution result of the function, to a second node; and
receiving, after transmitting the second packet, a third packet, which comprises the execution result of the function, from the second node,
wherein the first packet comprises at least one among information designating the function, information on at least one input variable for executing the function, and information for identifying the execution result of the function.

2. The method of claim 1, further comprising receiving, from the first node, a fourth packet that comprises information on an instance that is generated for executing the function.

3. The method of claim 1,
wherein the first node comprises a device having a resource for in-network computing, and
wherein the second node comprises a device having a storage means for storing and providing the execution result of the function.

4. The method of claim 1, further comprising determining an operation mode of the function among multiple candidate modes,
wherein the multiple candidate modes comprise a first mode, which obtains the execution result from a node executing the function, and a second node that obtains the execution result from a different node from the node executing the function.

5. The method of claim 1, wherein the information for identifying the execution result of the function comprises a key value that is to be used in a node providing the execution result.

6. The method of claim 1, wherein the information on at least one input variable for executing the function comprises information for identifying an execution result of another function.

7. The method of claim 1, further comprising:
generating a function call handler (FCH) for calling the function; and
generating a get result handler (GRH) for obtaining an execution result of the function,
wherein the FCH is deleted after requesting execution of the function by using the first packet, and
wherein the GRH is deleted after obtaining the execution result of the function by using the third packet.

8. The method of claim 7, further comprising determining, by using the FCH, a key value to be matched with the execution result of the function.

9. The method of claim 1, wherein the second packet comprises information for identifying the execution result of the function.

10. The method of claim 1, further comprising receiving a sixth packet that comprises information for identifying the execution result of the function.

11. A method for operating an in-network computing server in a name-based in-network distributed computing system, the method comprising:
receiving a first packet, which requests execution of a function, from a client device;
executing the function; and
transmitting, to a storage node, a second packet that requests to store an execution result of the function,
wherein the first packet comprises at least one among information designating the function, information on at least one input variable for executing the function, and information for identifying the execution result of the function.

12. The method of claim 11, further comprising transmitting, to the client device, a third packet comprising information on an instance that is generated for executing the function.

13. The method of claim 11, wherein the second packet comprises the execution result and information for identifying the execution result of the function.

14. The method of claim 11, wherein the information for identifying the execution result of the function comprises a key value that is to be used in the storage node.

15. The method of claim 11, wherein the executing of the function comprises:
allocating a computing resource for executing the function;
executing the function by using the computing resource; and
returning the computing resource, when it is confirmed that the execution result is stored in the storage node.

16. The method of claim 11,
wherein the executing of the function comprises generating an instance for executing the function, and
wherein the instance comprises an operation logic of the function, a function handler executing the operation logic and a result handler processing return of the execution result.

17. The method of claim 11, wherein the information on at least one input variable for executing the function comprises information for identifying an execution result of another function.

18. The method of claim 17, wherein the executing of the function comprises:
obtaining data, which comprises an execution result of the another function, from the storage node by using information for identifying the execution result of the another function; and
executing the function by using the data.

19. A client device in a name-based in-network distributed computing system, the client device comprising:
a transceiver configured to transmit and receive information: and
a processor configured to control the transceiver,
wherein the processor is further configured to:
transmit a first packet, which requests execution of a function, to a first node,
transmit a second packet, which requests an execution result of the function, to a second node, and
receive a third packet comprising the execution result of the function from the second node after transmitting the second packet, and
wherein the first packet comprises at least one among information designating the function, information on at least one input variable for executing the function, and information for identifying the execution result of the function.

20. An in-network computing server in a name-based in-network distributed computing system, the in-network computing server comprising:
a transceiver configured to transmit and receive information: and
a processor configured to control the transceiver,
wherein the processor is further configured to:
receive a first packet, which requests execution of a function, from a client device,
execute the function, and
transmit a second packet, which requests to store an execution result of the function, to a storage node, and
wherein the first packet comprises at least one among information designating the function, information on at least one input variable for executing the function, and information for identifying the execution result of the function.
